(19) United States
(12) Patent Application Publication
(10) Pub. No.: US 2012/0146883 A1
(43) Pub. Date: Jun. 14, 2012

(54) DISPLAY APPARATUS

(75) Inventors: Hyun Yong CHOI, Chuncheong-si (KR); Jae Hoo PARK, Suwon-si (KR)

(73) Assignee: SAMSUNG ELECTRONICS CO., LTD., Suwon-si (KR)

(21) Appl. No.: 13/315,438

(22) Filed: Dec. 9, 2011

(30) Foreign Application Priority Data
Dec. 10, 2010 (KR) 10-2010-0125967

(51) Int. Cl. G09G 5/00

(52) U.S. Cl. 345/1.1

(57) ABSTRACT

Disclosed herein is a display apparatus including a display panel which bilaterally displays images on opposites sides of the display panel and reverse to each other through opposite surfaces of the display panel A first case portion is provided with a first opening to expose a first surface of the display panel, and a second case portion is provided with a second opening to expose a second surface of the display panel opposite from the first surface and connected to the first case portion so that the display panel is installed between the first and second case portions. Therefore, the display apparatus which displays images through both surfaces thereof, has a small thickness.

### CROSS-REFERENCE TO RELATED APPLICATION

This application claims the benefit of Korean Patent Application No. 2010-0125967, filed on Dec. 10, 2010 in the Korean Intellectual Property Office, the disclosure of which is incorporated herein by reference.

### BACKGROUND

1. Field

Exemplary embodiments of the present inventive concept relate to a display apparatus which receives image data and then displays images.

2. Description of the Related Art

In general, display apparatuses include a display panel to display an image, and the display apparatus includes a liquid crystal panel or a PDP.

A display apparatus includes a display panel, a backlight unit disposed on the rear surface of the display panel, and a case provided with an opening which exposes a front surface of the display panel.

Recently, from among display apparatuses, there is a display apparatus in which, after openings are formed at both sides of a case, a display panel and a backlight unit are disposed, corresponding to the respective openings, so that images may be displayed on both sides of the display apparatus.

### SUMMARY

Therefore, it is an aspect of the present inventive concept to provide a display apparatus having a small thickness and which displays images on both sides of the display apparatus.

Additional aspects of the inventive concept will be set forth in part in the description which follows and, in part, will be obvious from the description, or may be learned by practice of the inventive concept.

In accordance with one aspect of the present inventive concept, a display apparatus includes a display panel which bilaterally displays images on opposite sides of the display panel and reverse to each other through both surfaces of the display panel, a first case portion provided with a first opening to expose a first surface of the display panel, and a second case portion provided with a second opening to expose a second surface of the display panel opposite from the first surface and connected to the first case portion so that the display panel is installed between the first and second case portions.

The first case portion and the second case portion may be formed of a transparent material.

The display panel may include panel circuit boards formed of a flexible material. The display apparatus may further include a control unit including a main circuit board connected to the panel circuit boards.

The control unit may further include a base plate on which the main circuit board is mounted and a cover connected to the base plate for covering the main circuit board.

Board installation parts corresponding to each other may be provided on the first case portion and the second case portion so that the panel circuit boards are installed between the board installation parts.

The board installation parts may be formed at the upper ends of the first case portion and the second case portion, and the control unit may be disposed on the outer surface of one of the board installation parts.

The display apparatus may further include a pair of wire support members installed on the control unit and a wire provided with both ends respectively installed at the pair of wire support members.

The display apparatus may further include a plurality of first latching protrusions provided in a hook shape on one of the first case portion and the second case portion and a plurality of latching parts provided on the other of the first case portion and the second case portion so that the plurality of first latching protrusions are locked with the plurality of latching parts, and the plurality of first latching protrusions and the plurality of latching parts may be formed along the edges of the first case portion and the second case portion.

The display apparatus may further include at least one installation hole provided on the base plate and at least one second latching protrusion protruding from one of the first case portion and the second case portion, extending sideways, passing through the at least one installation hole, and supported by a portion of the base plate adjacent to the at least one installation hole.

The main circuit board may include at least one input/output terminal to or from which image data is input or output. The main circuit board may further include a power supply terminal to supply power. A first through part may be provided on the cover at a position corresponding to the at least one input/output terminal and the power supply terminal.

The at least one input/output terminal and the power supply terminal may be disposed at the upper end of the main circuit board so as to face upwards, and the first through part may be formed at the upper end of the cover.

The main circuit board may include a connection terminal to which a connection line connected to the panel circuit boards is connected. A second through part and a third through part for passing the connection line may be provided on the cover and the base plate. A fourth through part may be provided on a second case portion.

In accordance with another aspect of the present inventive concept, a display apparatus includes a display panel, a case installed at a periphery of the display panel, a panel circuit board disposed inside of one end of the case, the one end having a width larger than other ends of the case and configured to drive the display panel, a main circuit board disposed at an outer side of the end portion and electrically connected to the panel circuit board to control the display panel, and a cover configured to cover the main circuit board.

The display panel includes a transparent display panel having both side surfaces passing light therethrough to the outside.

### BRIEF DESCRIPTION OF THE DRAWINGS

These and/or other aspects of the inventive concept will become apparent and more readily appreciated from the following description of the embodiments, taken in conjunction with the accompanying drawings of which:

FIG. 1 is a perspective view of a display apparatus in accordance with one exemplary embodiment;

FIG. 2 is an exploded perspective view of the display apparatus in accordance with the exemplary embodiment;

FIG. 3 is an exploded perspective view illustrating an installation state of a control unit applied to the display apparatus in accordance with the exemplary embodiment;

FIG. 4 is a perspective view of a main circuit board applied to the display apparatus in accordance with the exemplary embodiment;

FIG. 5 is a cross-sectional view illustrating a connection state between a first case portion and a second case portion of the display apparatus in accordance with the exemplary embodiment;

FIG. 6 is a cross-sectional view illustrating a connection state between a base plate and the second case portion of the display apparatus in accordance with the exemplary embodiment; and

FIG. 7 is a perspective view of a circuit board applied to a display apparatus in accordance with another exemplary embodiment.

### DETAILED DESCRIPTION

Reference will now be made in detail to the exemplary embodiments of the present inventive concept, examples of which are illustrated in the accompanying drawings, wherein like reference numerals refer to like elements throughout.

Hereinafter, a display apparatus in accordance with one exemplary embodiment of the present inventive concept will be described with reference to the accompanying drawings.

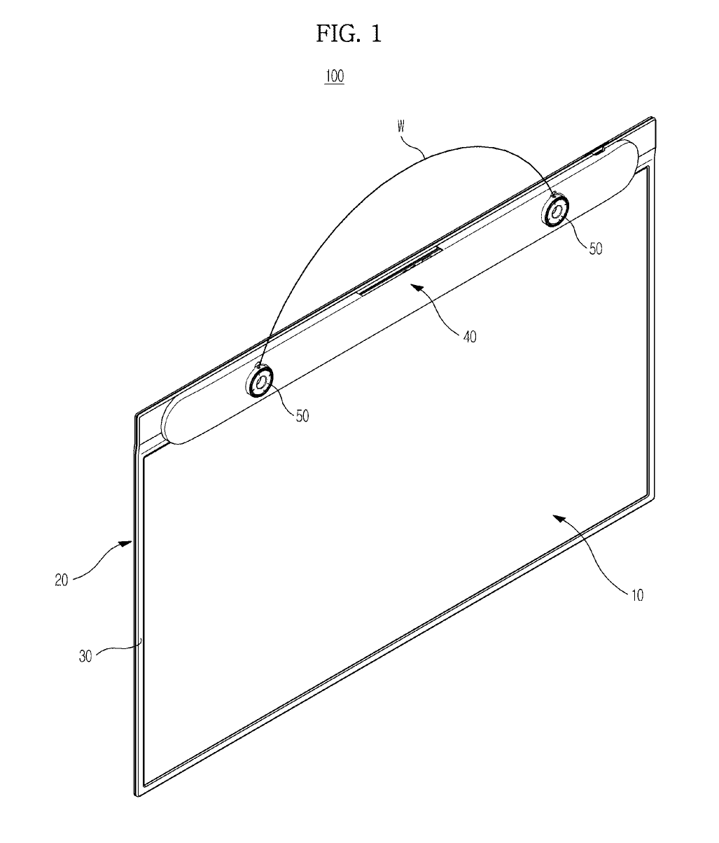

As shown in FIG. 1, a display apparatus 100 in accordance with this exemplary embodiment includes a display panel 10 and case portions 20 and 30, the case portions 20 and 30 installed at a periphery of the display panel 10.

The display panel 10 is a color liquid crystal panel. In addition, the display panel 10 is formed using a transparent display having both side surfaces that allow light having passed through liquid crystal elements forming display panel 10 to be transmitted to the outside therethrough. Therefore, images bilaterally reverse and opposite to each other are displayed on both side surfaces of display panel 10 applied to this exemplary embodiment.

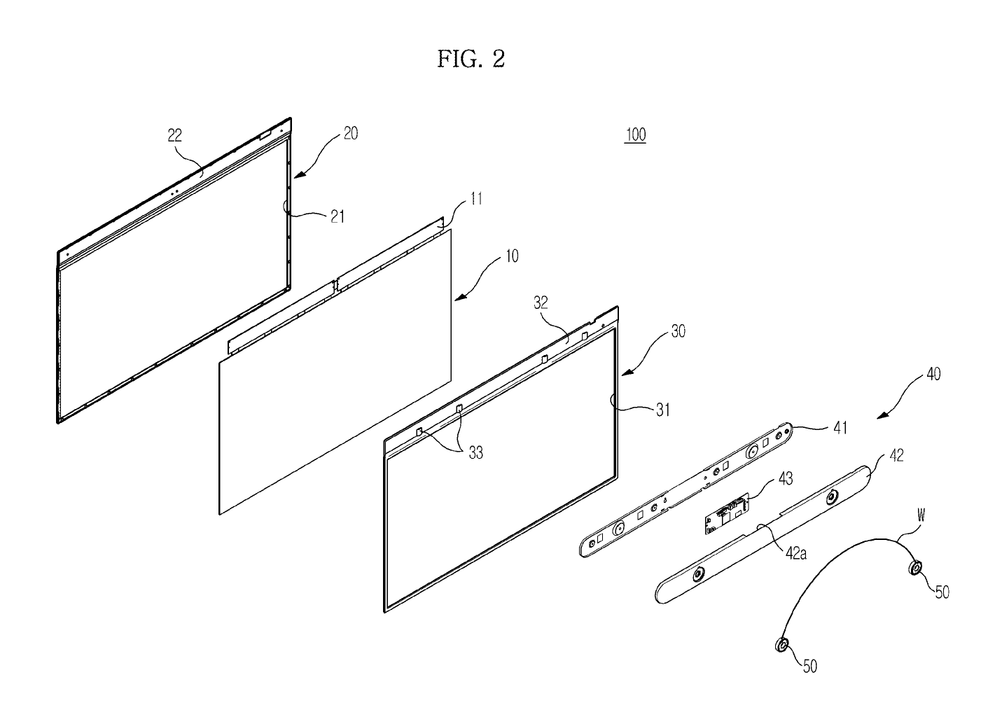

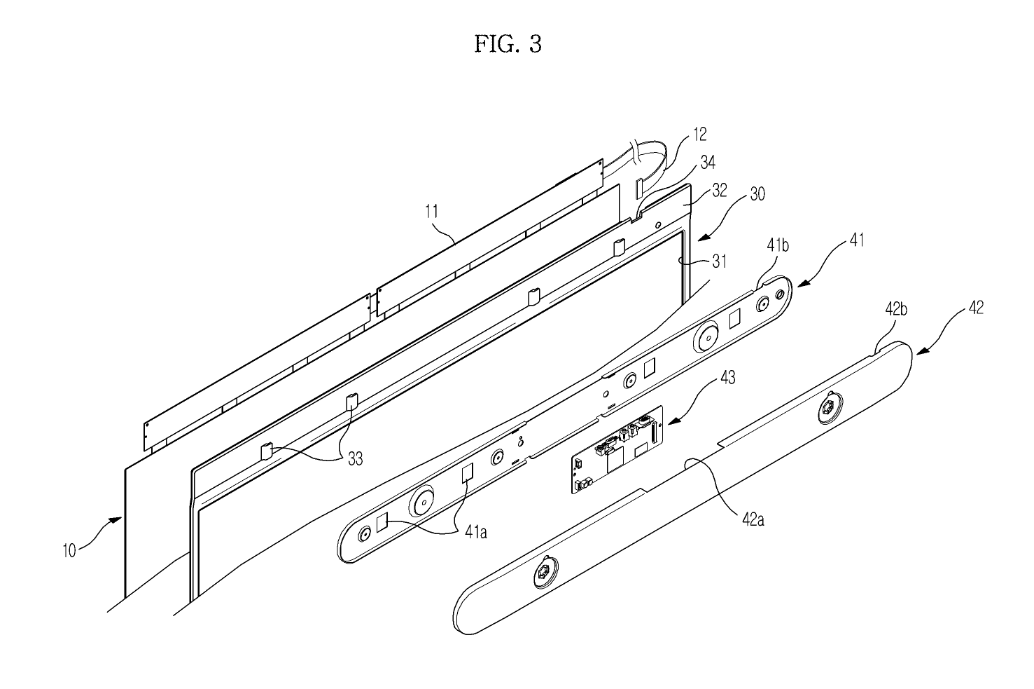

As shown in FIGS. 2 and 3, panel circuit boards 11, formed of a flexible material and transmit an electrical signal to the respective liquid crystal elements in order to respectively operate the liquid crystal elements, are connected to the upper end of display panel 10.

In this exemplary embodiment, display panel 10 which is operated by light generated by an external lighting device to light an indoor space without a component corresponding to a backlight unit, is applied. Since display apparatus 100 may be operated through the external lighting device without installation of a light source within display apparatus 100, the thickness of display apparatus 100 which displays images on both side surfaces thereof, may be reduced.

The case portions 20 and 30 are formed of a transparent material so as to more easily transmit light generated from the external lighting device to display panel 10. Case portions 20 and 30 include a first case portion 20 and a second case portion 30 which are connected to each other so that display panel 10 is installed therebetween. First case portion 20 is provided with a first opening 21 to expose a first surface of display panel 10, and second case portion 30 is provided with a second opening 31 to expose a second surface of display panel 10, opposite to the first surface.

Therefore, the first surface and the second surface of display panel 10 are exposed to the outside through first opening 21 and the second opening 31, and thus images bilaterally reverse to each other, displayed on the first and second display surfaces of display panel 10, may be seen from the outside.

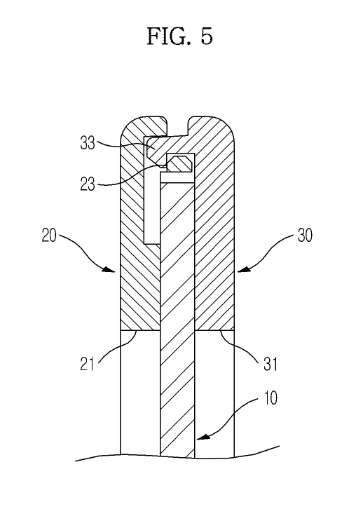

First case portion 20 and second case portion 30 may be connected to each other through methods, such as snap fittings or fusion. In this exemplary embodiment, first case portion 20 and second case portion 30 are connected to each other through snap fittings, as shown in FIG. 5. For this purpose, latching parts 23 (FIG. 5) formed in a groove or hole shape are provided on the first case portion 20, and first latching protrusions 33 are formed in a hook shape at positions corresponding to latching parts 23 and are locked with latching parts 23 provided on second case portion 30. Here, a plurality of latching parts 23 and a plurality of first latching protrusions 33 are formed along the edges of the first case 20 and the second case 30.

With reference to FIG. 2, upper ends of the first case portion 20 and the second case portion 30 each have a width larger than that of other ends of the first case portion 20 and the second case portion 30. The upper ends of the first case portion 20 and the second case portion 30 form a first board installation part 22 and a second board installation part 32, respectively, that interpose a panel circuit board 11 therebetween.

Display apparatus 100 includes a control unit 40 for controlling display apparatus 100. Control unit 40 is installed at one side of the case portions 20 and 30. In this exemplary embodiment, control unit 40 is installed at the second board installation part 32 of the second case portion 30, thus allowing panel circuit boards 11 to be easily connected to a main circuit board 43 of control unit 40, which will be described later.

Control unit 40 includes main circuit board 43 connected to panel circuit boards 11 through a connection line 12 to control operation of display panel 10, a base plate 41, on which main circuit board 43 is mounted, installed on the board installation parts 22 and 32 of the case portions 20 and 30, and a cover 42 connected to the base plate 41 through screws, etc. to cover main circuit board 43 mounted on base plate 41.

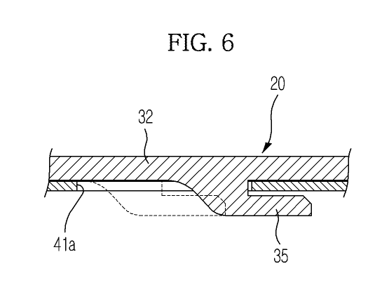

Installation holes 41a are provided on base plate 41 of control unit 40 so as to install control unit 40 on case portions 20 and 30, and second latching protrusions 35 protruding toward base plate 41 and extending sideways are provided on second case portion 30. In this embodiment, first latching protrusions 33 extend integrally from second board installation part 32 of second case portion 30. Therefore, when base plate 41 moves sideways, after base plate 41 is installed such that second latching protrusions 35 pass through installation holes 41a. As shown in FIG. 6, second latching protrusions 35 are hung on and supported by portions of base plate 41 adjacent to installation holes 41a, and thus the base plate 41 is installed on the case portions 20 and 30.

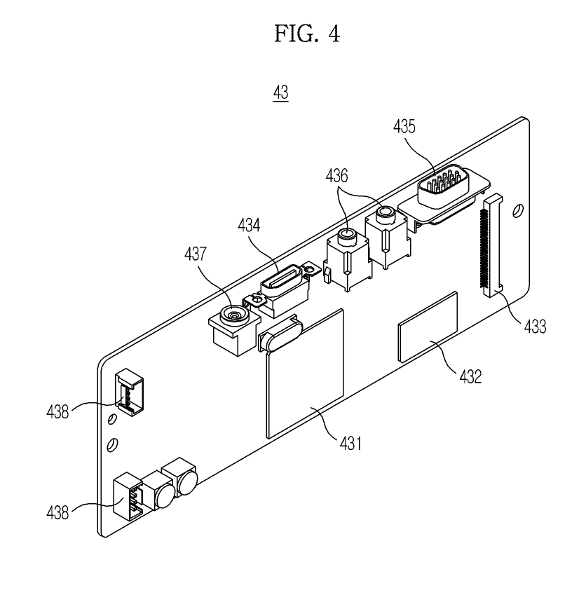

As shown in FIG. 4, a CPU 431 to process data, a memory 432 to store data, a connection terminal 433 to which the connection line 12 extending from panel circuit board 11 is connected in order to connect main circuit board 43 and panel circuit boards 11 to each other. Various input/output terminals 434, 435 and 436 are provided to input and output image data. A power supply terminal 437 to which a power line is connected to receive power from the outside, and connection terminals 438 to which a switch provided on display apparatus 100 or a receiver of a remote controller is connected in order to operate display apparatus 100, are disposed on main circuit board 43. In this embodiment, input/output terminals 434, 435 and 436 include an HDMI terminal 434 to input an image signal, a D-sub terminal 435 and an audio input terminal 436.

In this embodiment, input/output terminals 434, 435 and 436 and power supply terminal 437 are disposed at the upper end of the main circuit board 43 while facing upwards to be easily connected to input/output lines and a power line extending from the ceiling. And a first through part 42a formed in a groove shape by cutting a part of cover 42 is provided at the upper end of cover 42 so as to allow the input/output lines and the power line to be connected to input/output terminals 434, 435 and 436 and power supply terminal 437, as shown in FIG. 3.

Further, a second through part 42b, a third through part 41b and a fourth through part 34 are provided at the upper end of the cover 42, the upper end of the base plate 41 and the upper end of the second case portion 30 at positions corresponding to one another so as to allow panel circuit boards 11 and main circuit board 43 to be connected to each other.

In this embodiment, images are displayed on both surfaces of display panel 10 of display apparatus 100, and thus display apparatus 100 may be installed at a place allowing both sides of display apparatus 100 to be opened rather than a place allowing one side of the display apparatus to be closed, such as a wall. Therefore, in this embodiment, display apparatus 100 is installed under the condition that display apparatus 100 is hung on the ceiling through a wire W.

In order to install display apparatus 100 in such a manner, a pair of wire support members 50 for supporting wire W are installed on both sides of control unit 40, as shown in FIG. 2, and both ends of the wire W are respectively fixed to wire support members 50. Therefore, display apparatus 100 may be hung on the ceiling by hanging the central portion of wire W to a hook fixed to the ceiling (not shown).

Although this embodiment illustrates first board installation part 22 and second board installation part 32 as being respectively formed at the upper ends of first case portion 20 and second case portion 30, the position of first board installation part 22 and second board installation part 32 are not limited thereto. That is, first board installation part 22 and second board installation part 32 may be formed by increasing the width of the side ends or the lower ends of first case portion 20 and second case portion 30 such that the side ends or the lower ends of the first case portion 20 and the second case portion 30 each have a width larger than other ends of the first case portion 20 and the second case portion 30.

Although this embodiment illustrates display panel 10 as displaying images using light transmitted from the external lighting device, the display panel 10 is not limited thereto. That is, a light source, such as light emitting diodes, may be installed on case portions 20 or 30 or control unit 40 so that images may be formed on both side surfaces of the display panel 10 using light generated from the light source.

Although this embodiment illustrates control unit 40 as being installed at second board installation part 32 provided on second case portion 30, the position of control unit 40 is not limited thereto. That is, control unit 40 may be installed at the outside of display apparatus 100 and then be connected to panel circuit boards 110 through a wire.

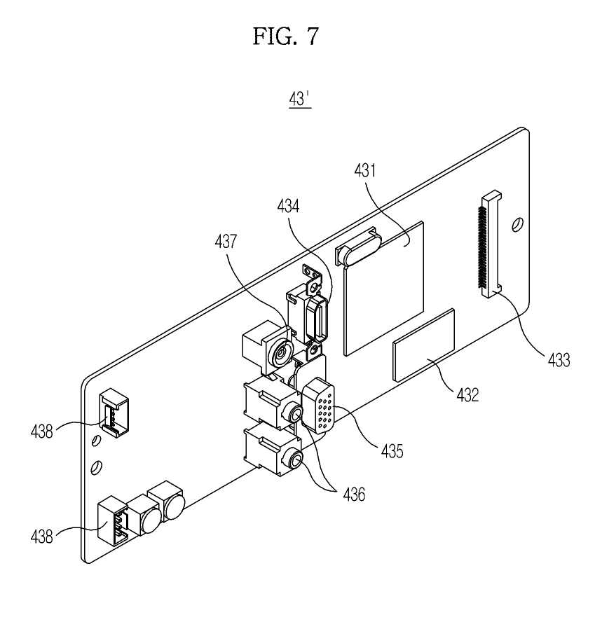

Further, although this embodiment illustrates input/output terminals 434, 435 and 436 and power supply terminal 437 as being disposed at the upper end of main circuit board 43 while facing upwards so as to be easily connected to the input/output lines and the power line extending from the ceiling, disposition of input/output terminals 434, 435 and 436 and power supply terminal 437 is not limited thereto. That is, input/output terminals 434, 435 and 436 and power supply terminal 437 may face to the front surface of cover 42, as shown in FIG. 7, so as to be easily connected to input/output lines and a power line extending from a region in front of cover 42.

As is apparent from the above description, a display apparatus in accordance with one exemplary embodiment uses one display panel which displays images through both surfaces thereof. Thus, the display apparatus which displays the images through both surfaces thereof may have a small thickness.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A display apparatus comprising:
a display panel which bilaterally displays images on opposite sides of the display panel and reverse to each other through opposite surfaces of the display panel;
a first case portion provided with a first opening to expose a first surface of the display panel; and
a second case portion provided with a second opening to expose a second surface of the display panel opposite to the first surface and connected to the first case portion so that the display panel is installed between the first and second case portions.

2. The display apparatus according to claim 1, wherein
the first case portion and the second case portion are formed of a transparent material.

3. The display apparatus according to claim 1, wherein the display panel includes panel circuit boards formed of a flexible material; and
the display apparatus further comprises a control unit including a main circuit board connected to the panel circuit boards.

4. The display apparatus according to claim 3, wherein
the control unit further includes a base plate on which the main circuit board is mounted, and a cover connected to the base plate to cover the main circuit board.

5. The display apparatus according to claim 4, wherein
board installation parts corresponding to each other are provided on the first case portion and the second case portion so that the panel circuit boards are installed between the board installation parts.

6. The display apparatus according to claim 5, wherein
the board installation parts are formed at the upper ends of the first case portion and the second case portion, and the control unit is disposed on the outer surface of one of the board installation parts.

7. The display apparatus according to claim 6, further comprising:
a pair of wire support members installed on the control unit; and
a wire provided with both ends respectively installed at the pair of wire support members.

8. The display apparatus according to claim 1, further comprising:
a plurality of first latching protrusions provided in a hook shape on one of the first case portion and the second case portion; and
a plurality of latching parts provided on the other of the first case portion and the second case portion so that the plurality of first latching protrusions are locked with the plurality of latching parts,
wherein the plurality of first latching protrusions and the plurality of latching parts are formed along the edges of the first case portion and the second case portion.

9. The display apparatus according to claim 4, further comprising:
at least one installation hole provided on the base plate; and
at least one second latching protrusion protruding from one of the first case portion and the second case portion, extending sideways, passing through the at least one installation hole, and supported by a portion of the base plate adjacent to the at least one installation hole.

10. The display apparatus according to claim 4, wherein
the main circuit board includes at least one input/output terminal to or from which image data is input or output, and a power supply terminal to supply power; and
a first through part is provided on the cover at a position corresponding to the at least one input/output terminal and the power supply terminal.

11. The display apparatus according to claim 10, wherein the at least one input/output terminal and the power supply terminal are disposed at the upper end of the main circuit board so as to face upwards; and
the first through part is formed at the upper end of the cover.

12. The display apparatus according to claim 4, wherein the main circuit board includes a connection terminal to which a connection line connected to the panel circuit boards is connected; and
a second through part and a third through part to pass the connection line are provided on the cover and the base plate, and a fourth through part to pass the connection line is provided on the second case portion.

13. A display apparatus comprising:
a display panel;
a case installed at a periphery of the display panel;
a panel circuit board disposed inside of one end of the case, the one end having a width larger than other ends of the case and configured to drive the display panel;
a main circuit board disposed at an outer side of the end portion and electrically connected to the panel circuit board to control the display panel; and
a cover configured to cover the main circuit board.

14. The display apparatus of claim 14, wherein the display panel comprises a transparent display panel having both side surfaces passing light therethrough to the outside.

15. The display apparatus of claim 13, further comprising a base plate that is disposed on the one end such that the main circuit board is installed on the base plate, wherein
the cover covers the main circuit board installed on the base plate.

16. The display apparatus of claim 13, further comprising:
a connection terminal configured to the panel circuit board to the main circuit board.

17. The display apparatus of claim 13, further comprising:
a wire having two ends that are installed on the cover.

18. The display apparatus of claim 17, further comprising a pair of wire support members installed on the cover, wherein the two ends of the wire are installed on the pair of wire support members, respectively.
